(19) United States
(12) Patent Application Publication
(10) Pub. No.: US 2007/0175937 A1
(43) Pub. Date: Aug. 2, 2007

(54) Foldable carrier rack for all terrain vehicles and method

(76) Inventor: Craig Caldwell, Tempe, AZ (US)

Correspondence Address: WEISS & MOY PC, 4204 NORTH BROWN AVENUE, SCOTTSDALE, AZ, 85251, US

(21) Appl. No.: 11/345,213

(22) Filed: Feb. 1, 2006

(51) Int. Cl. B60R 9/00; B60R 7/00

(52) U.S. Cl. 224/401; 224/504

(57) ABSTRACT

A foldable rack apparatus comprises a base and a rack that is pivotably coupled to the base. The apparatus is secured to an all terrain vehicle (ATV). A coupling member allows the rack to fold when not in use, so as to not increase a length of an ATV to which the rack apparatus is secured.

### FIELD OF THE INVENTION

This invention relates generally to carrier racks for all terrain vehicles (ATVs) and, more particular, to a foldable carrier rack that does not increase certain external dimensions of an ATV when in a folded position.

### BACKGROUND OF THE INVENTION

ATVs, whether having three or four wheels, are commonly used. ATVs may be used for recreation, or for more practical purposes, such as on farms, golf courses, or other locations where the terrain is not conducive to other modes of transportation, or where the amount of area that needs to be covered is too vast for walking. Recreational riders, or others that plan on hours of riding, often prefer to bring along a cooler for drinks. In addition, it is often necessary for the ATV rider to carry equipment, tools, or other items, so that they may be used on the property by the rider of the ATV. In the prior art, there are examples of rack systems that have been created for ATVs. However, a limitation exists with the prior art systems in that they alter the external configuration of the ATV by making the ATV longer and/or higher than it would otherwise be. When it becomes necessary to transport the ATV—on a trailer, for example—the alteration of the ATV's external dimensions caused by the external rack can make it more difficult, if not impossible, to effectively transport the ATV.

A need therefore exists for a rack apparatus for an ATV that does not alter the external dimensions of the ATV.

The present invention satisfies these needs and provides other, related, advantages.

### SUMMARY OF THE INVENTION

In accordance with an embodiment of the present invention, a foldable carrier rack apparatus for an ATV is disclosed. The apparatus comprises, in combination: a base portion adapted to be coupled to an ATV below a seat and terminating prior to a rearmost end of the seat; a rack adapted to be pivotably coupled to the base portion; and at least one coupling member adapted to pivotably couple the rack to the base portion so that the rack can be alternately positioned in a first orientation wherein the rack portion is substantially horizontal to a ground below the ATV and a second orientation wherein the rack portion is located directly below and forward of the rearmost end of the seat.

In accordance with another embodiment of the present invention, a foldable carrier rack apparatus for an ATV is disclosed. The apparatus comprises, in combination: a base portion adapted to be coupled to an ATV below a seat and terminating prior to a rearmost end of the seat, wherein the base portion comprises a pair of rails adapted to be coupled to opposing sides of the ATV and an elongated base member attached to each of the rails; a rack; and first and second coupling members adapted to pivotably couple the rack to the elongated base members so that the rack can be alternately positioned in a first orientation wherein the rack portion is substantially horizontal to a ground below the ATV and a second orientation wherein the rack portion is located directly below and forward of the rearmost end of the seat.

In accordance with a further embodiment of the present invention, a method for transporting items on a rear portion of an ATV is disclosed. The method comprises: providing an ATV; providing a foldable carrier rack for the ATV, comprising a base portion adapted to be coupled to an ATV below a seat and terminating prior to a rearmost end of the seat, a rack adapted to be pivotably coupled to the base portion, and at least one coupling member adapted to pivotably couple the rack to the base portion so that the rack can be alternately positioned in a first orientation wherein the rack portion is substantially horizontal to a ground below the ATV and a second orientation wherein the rack portion is located directly below and forward of the rearmost end of the seat; securing the rack in the first orientation; loading items onto the rack; transporting the items by operating the ATV; unloading the items; and securing the rack in the second orientation.

### BRIEF DESCRIPTION OF THE DRAWINGS

FIG. 1 is a perspective view of a rack apparatus, consistent with an embodiment of the present invention.

FIG. 2 is a top view of the rack apparatus of FIG. 1.

FIG. 3 is a side view of a rack apparatus installed on an ATV, consistent with an embodiment of the present invention, illustrating a first and second orientation of a rack portion of a rack apparatus, with the second orientation being shown in phantom.

FIG. 4 is a cross-sectional view of a coupling member at a first attachment point on a rack apparatus consistent with an embodiment of the present invention.

FIG. 5 is a cross-sectional view of a coupling member at a second attachment point on a rack apparatus consistent with an embodiment of the present invention.

### DETAILED DESCRIPTION OF THE PREFERRED EMBODIMENTS

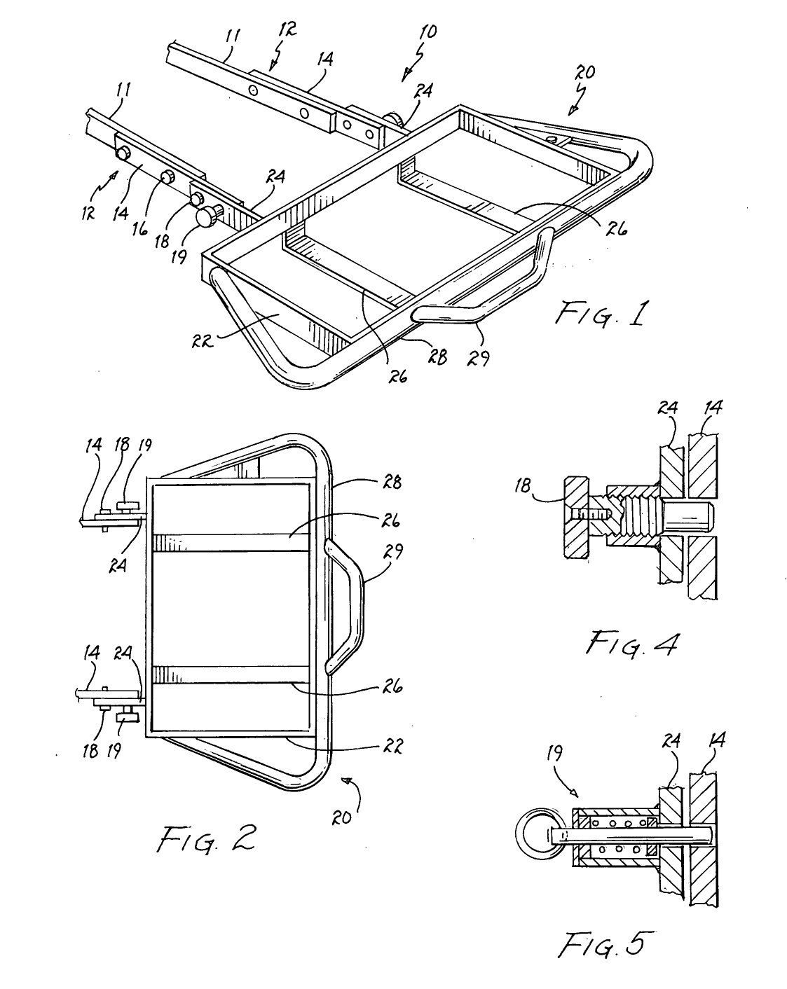

Referring first to FIGS. 1-3, an embodiment of a rack apparatus 10 consistent with an embodiment of the present invention is shown. The rack apparatus 10 can be divided into two principal components: a base portion 12 and a rack 20 which is pivotably coupled to the base portion 12.

In this embodiment, the base portion 12 comprises a pair of rails 11, which may be bolted or otherwise coupled to opposing sides of an ATV. In turn, an elongated base member 14 is attached to each of the rails 11, with securing bolts 16 or otherwise. It is further preferred to provide on the elongated base members 14 a second plurality of openings corresponding to openings in connecting members 24, which extend forward from the rack 20. As shown in these figures, the rearmost portion of the elongated base members 14 should terminate prior to the end of a seat on an ATV, so as to not increase the length of the ATV when the rack 20 is in a folded orientation, as herein described.

In this embodiment, the base portion 12 is pivotably coupled to the rack 20 by a first coupling member 18 and a second coupling member 19, which are inserted through aligned openings in the connecting members 24 and rack 20. The first coupling member 18, in this embodiment, is a pivotable fastener, such as a pivot bolt. The second coupling member 19 is a removable fastener, such as a quick release pin.

The rack 20, in the embodiment shown in FIGS. 1-3, consists of a frame 22 with horizontally spaced supports 26. An extension frame 28, as shown in this embodiment, may be attached to the frame 22 on the three sides of the frame 22 furthest from the base portion 12, so as to increase the surface area of the rack 20. It may be desired, as shown in FIGS. 1-2, to configure the extension frame 28 so that it tapers outward from the portion of the rack 20 most proximate to the base portion 12, so as to limit the extent to which the rack 20 may protrude to the side when the rack 20 is in a folded orientation. A handle 29 that may be substantially coplanar with the rack 20 may be attached to the extension frame 28, extending beyond the rear portion of the rack 20. Preferably, the rack 20 is composed of heavy-duty material, such as steel or aluminum, but could also be composed of plastic or some other desired material.

Referring to FIG. 4, an embodiment of a coupling member 18 at a first attachment point on a rack apparatus 10 consistent with an embodiment of the present invention is shown. In this embodiment, the coupling member 18 is a pivot bolt, but some other type of pivotable fastener could be used. The coupling member couples the elongated base members 14 to the connecting members 24.

Referring to FIG. 5, an embodiment of a coupling member 19 at a second attachment point on a rack apparatus 10 consistent with an embodiment of the present invention is shown. In this embodiment, the coupling member 19 is a quick release pin, but some other type of removable fastener could be used. The coupling member 19 further couples the elongated base members 14 to the connecting members 24 when the rack portion 20 (as shown in FIG. 1) is in a horizontal position.

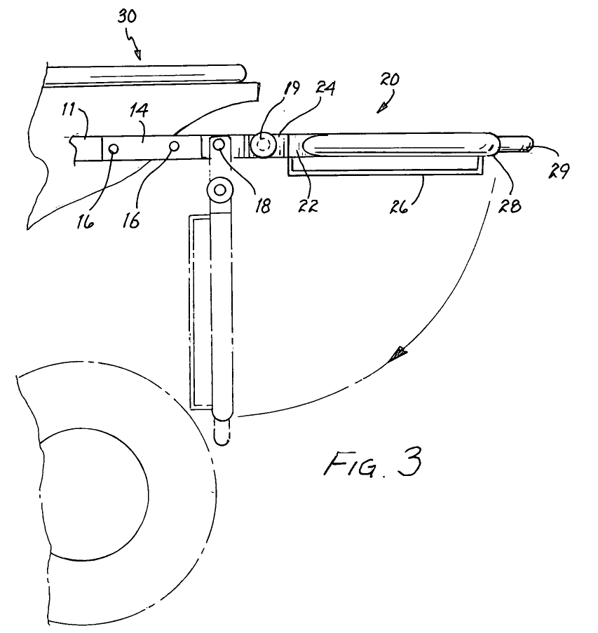

It should be apparent that the coupling of both the coupling member 18 and the coupling member 19 will prevent the rack 20 from rotating relative to the base portion 12. However, withdrawal of the coupling members 19, so that they are no longer inserted through openings in each of the base members 14 and the connecting members 24, will permit the rack 20 to rotate/fold relative to the base portion 12. In this manner, the rack 20 can be rotated about the first coupling member 18 and moved from a first orientation, substantially parallel to ground located below the ATV, to a folded orientation relative to the base portion 12, as shown by way of example in FIG. 3. Withdrawal of each of the coupling members 18 and coupling members 19 would permit detachment of the rack 20 from the base portion 12.

While the invention has been particularly shown and described with reference to preferred embodiments thereof, it will be understood by those skilled in the art that the foregoing and other changes in form and details may be made therein without departing from the spirit and scope of the invention. For example, it may be desired to configure the base portion 12 as a single pair of opposing rails, rather than as a pair of rails 11 that are coupled to a pair of elongated base members 14. It may be desired to provide a solid surface for the rack 20 and/or to eliminate or differently configure the extension bar 28. It may also be desired to provide a single coupling member, rather than first and second coupling members, to facilitate the locking into position of the rack 20 relative to the base portion 12 and the folding of the rack 20 relative to the base portion 12. It may also be desired to accomplish pivoting of the rack 20 by establishing a hinged relationship between the base portion 12 and the rack 20, rather than using coupling members 18 and 19.

### STATEMENT OF OPERATION

In order to position the rack 20 so that it may be used to hold and transport items, a user would lift the rack 20 so that it is substantially horizontal to the ground below the ATV. After ensuring that the openings in the connecting members 24 are aligned, the user would insert the second coupling members 19. To stow the rack 20, the user would remove the second coupling members 19 and lower the rack 20, until it reaches a point that is forward the rearmost end of the seat of the ATV.

I claim:

1. A foldable carrier rack for an ATV comprising, in combination:
a base portion adapted to be coupled to an ATV below a seat and terminating prior to a rearmost end of the seat;
a rack adapted to be pivotably coupled to the base portion; and
at least one coupling member adapted to pivotably couple the rack to the base portion so that the rack can be alternately positioned in a first orientation wherein the rack portion is substantially horizontal to a ground below the ATV and a second orientation wherein the rack portion is located directly below and forward of the rearmost end of the seat.

2. The foldable carrier rack of claim 1 further comprising first and second coupling members.

3. The foldable carrier rack of claim 2 wherein the first coupling member is a pivot bolt.

4. The foldable carrier rack of claim 3 wherein the second coupling member is a quick release pin.

5. The foldable carrier rack of claim 1 wherein the base portion comprises:
a pair of rails adapted to be coupled to opposing sides of the ATV; and
an elongated base member attached to each of the rails.

6. A foldable carrier rack for an ATV comprising, in combination:
a base portion adapted to be coupled to an ATV below a seat and terminating prior to a rearmost end of the seat;
wherein the base portion comprises:
a pair of rails adapted to be coupled to opposing sides of the ATV; and
an elongated base member attached to each of the rails;
a rack; and
first and second coupling members adapted to pivotably couple the rack to the elongated base members so that the rack can be alternately positioned in a first orientation wherein the rack portion is substantially horizontal to a ground below the ATV and a second orientation wherein the rack portion is located directly below and forward of the rearmost end of the seat.

7. The foldable carrier rack of claim 6 wherein the first coupling member is a pivot bolt.

8. The foldable carrier rack of claim 7 wherein the second coupling member is a quick release pin.

9. A method for transporting items on a rear portion of an ATV comprising:
providing an ATV;
providing a foldable carrier rack for the ATV comprising:
a base portion adapted to be coupled to an ATV below a seat and terminating prior to a rearmost end of the seat;
a rack adapted to be pivotably coupled to the base portion; and
at least one coupling member adapted to pivotably couple the rack to the base portion so that the rack can be alternately positioned in a first orientation wherein the rack portion is substantially horizontal to a ground below the ATV and a second orientation wherein the rack portion is located directly below and forward of the rearmost end of the seat;
securing the rack in the first orientation;
loading items onto the rack;
transporting the items by operating the ATV;
unloading the items; and
securing the rack in the second orientation.

10. The method of claim 9 wherein the foldable carrier rack further comprises first and second coupling members.

11. The method of claim 10 wherein the first coupling member is a pivot bolt.

12. The method of claim 11 wherein the second coupling member is a quick release pin.

13. The method of claim 9 wherein the base portion comprises:
a pair of rails adapted to be coupled to opposing sides of the ATV; and
an elongated base member attached to each of the rails.
